(19) United States
(12) Patent Application Publication
(10) Pub. No.: US 2014/0118261 A1
(43) Pub. Date: May 1, 2014

(54) INPUT DEVICE COMPRISING GEOMAGNETIC SENSOR AND ACCELERATION SENSOR, DISPLAY DEVICE FOR DISPLAYING CURSOR CORRESPONDING TO MOTION OF INPUT DEVICE, AND CURSOR DISPLAY METHOD THEREOF

(71) Applicant: SAMSUNG ELECTRONICS CO., LTD., Gyeonggi-do (KR)

(72) Inventors: Mun-cheol CHOI, Yongin-si (KR); Sang-on CHOI, Yongin-si (KR); Woo-jong CHO, Yongin-si (KR)

(73) Assignee: SAMSUNG ELECTRONICS CO., LTD., Gyeoggi-do (KR)

(21) Appl. No.: 14/147,079

(22) Filed: Jan. 3, 2014

Related U.S. Application Data
(62) Division of application No. 11/646,504, filed on Dec. 28, 2006.

(30) Foreign Application Priority Data
Jun. 8, 2006 (KR) 10-2006-0051342

(51) Int. Cl. G06F 3/0346

(52) U.S. Cl. CPC G06F 3/0346
USPC 345/158

(57) ABSTRACT

A display device for displaying a cursor according to motion of an input device is provided. The input device comprises an input part which receives pitch angle information and yaw angle information corresponding to motion of an external input device; a computation part which computes a first relative angle corresponding to the information of the pitch angle and a second relative angle corresponding to the information of the yaw angle; a coordinate calculator which calculates a cursor coordinate value which gradually varies according to the changes of the first and second relative angles; and a display which displays a cursor on a position corresponding to the calculated cursor coordinate value. Thus, it is possible to avoid trembling of the cursor caused by noise.

### CROSS-REFERENCE TO RELATED APPLICATIONS

This is a Divisional of U.S. application Ser. No. 11/646,504 filed Dec. 28, 2006, which claims priority under 35 U.S.C. §119 from Korean Patent Application No. 10-2006-0051342, filed on Jun. 8, 2006, in the Korean Intellectual Property Office, the disclosure of which is incorporated herein by reference in its entirety.

### BACKGROUND OF THE INVENTION

1. Field of the Invention

Apparatuses and methods consistent with the present invention relate to an input device, a display device for displaying a cursor corresponding to a motion of the input device, and a cursor display method, and more particularly, to an input device comprising a geomagnetic sensor and an acceleration sensor, a display device for displaying a cursor according to variation in a pitch angle and a yaw angle of the input device, and a cursor display method.

2. Description of the Related Art

With the development of electronic technologies, display devices have been provided with various functions. To effectively utilize various functions, generally a cursor is displayed on a display screen and the cursor's position on the display screen is moved to allow a user to easily select a desired function.

To this end, it is necessary to move the position of the cursor by using an input device such as a mouse, a remote controller, or a joystick. For example, if the mouse is used, the user moves the cursor to correspond to a motion direction of the mouse so that the cursor can be located on a desired menu. However, the related art input device such as the mouse has a drawback in that it is operated only on a plane.

To overcome the drawback, there is a need for a technique for controlling a cursor using an input device moving on a three-dimensional space, not only along a plane. Thus, an input device operated on a three-dimensional space using a rotational angle sensor, such as a gyroscope sensor, has been developed. However, in case of the gyroscope sensor, the sensor is expensive and offset characteristics of the sensor cannot be overcome. In other words, the cursor may be moved even when there is no motion due to the offset characteristics of the gyroscope sensor.

If a geomagnetic sensor is used as the input device in order to solve the problems associated with the gyroscope sensor, another problem occurs in that trembling of the cursor occurs due to noise caused by peripheral magnetism. For example, a pitch angle of the input device trembles in the range of ±0.4° in a state where the input device is not operated. Also, a yaw angle of the input device trembles in the range of ±1.5° without separate signal processing in a state where the input device is not operated. The yaw angle trembles in the range of ±0.4° even in case that 10 data are processed at an average value.

Generally, the pitch angle is used to control up and down motion of the cursor, while the yaw angle is used to control left and right motion of the cursor. Accordingly, if the pitch angle and the yaw angle tremble, the cursor unstably trembles in all directions. For example, in case of a display having resolution of 1280*1024 resolution, if the pitch angle trembles in the range of ±0.4°, the cursor trembles up and down over a maximum of 40 pixels. Also, if the yaw angle trembles in the range of ±1.5°, the cursor trembles in left and right directions over a maximum of 48 pixels. Even in case of average process, the cursor trembles in left and right directions over maximum 12 pixels.

Meanwhile, in order to remove noise, a Bessel low pass filter can be used. Specifically, a Bessel low pass filter is designed in a secondary filter type having a high cutoff frequency of 5 Hz and a low cutoff frequency of 3 Hz in order to remove noise. However, the noise is not completely removed even if the Bessel filter is used. Also, time delay occurs due to filtering. Accordingly, if the Bessel low pass filter is used, the cursor does not move immediately in response to motion by the user, which is inconvenient.

### SUMMARY OF THE INVENTION

Exemplary embodiments of the present invention overcome the above and other disadvantages. Also, the present invention is not required to overcome the disadvantages described above, and an exemplary embodiment of the present invention may not overcome any of the problems described above.

The present invention provides a display device and a cursor display method thereof, in which a cursor moves gradually based on the motion of an input device to avoid trembling caused by noise, and also avoid time delay.

The present invention also provides an input device comprising a geomagnetic sensor and an acceleration sensor to gradually move a cursor on a display device.

According to an aspect of the present invention, there is provided a display device comprising an input part receiving pitch angle and yaw information corresponding to motion of an external input device; a computation part computing a first relative angle corresponding to the information of the pitch angle and a second relative angle corresponding to the information of the yaw angle; a coordinate calculator calculating a cursor coordinate value which gradually varies according to the changes of the first and second relative angles; and a display displaying a cursor on a position corresponding to the calculated cursor coordinate values.

The computation part computes the first and second relative angles by using the following equations (1) and (2):

θᵣ=θₜ−θᵢₙᵢₜ (1)

ψᵣ=ψₜ−ψᵢₙᵢₜ (2)

if ψᵣ≧0.0 ψᵣ<=ψᵣ−180, else ψᵣ<=ψᵣ+180
then, if ψᵣ<0.0 ψᵣ<=ψᵣ+180, else ψᵣ<=ψᵣ−180,
where θᵣ represents the first relative angle, θₜ the pitch angle, θᵢₙᵢₜ a previously set initial pitch angle, ψᵣ the second relative angle, ψₜ the yaw angle, and ψᵢₙᵢₜ a previously set initial yaw angle.

The coordinate calculator calculates primary cursor coordinate values corresponding to the first and second relative angles by using the following equations (1) and (2), calculates the primary cursor coordinate values as final cursor coordinate values if the calculated cursor coordinate values are different from previous cursor coordinate values by more than a number of pixels, and calculates the previous cursor coordinate values as the final cursor coordinate values if the calculated cursor coordinate values are different from the previous cursor coordinate values by less than a number of pixels:

$$\begin{matrix}{P}_{x} = ( \frac{\frac{{N}_{x}}{2}}{{ψ}_{max}} ) {ψ}_{r} + \frac{{N}_{x}}{2} & ( 1 ) \\ {P}_{y} = ( \frac{\frac{{N}_{y}}{2}}{{θ}_{max}} ) {θ}_{r} + \frac{{N}_{y}}{2} , & ( 2 )\end{matrix}$$

where Pₓ and P_{y} represent the calculated X and Y axis primary cursor coordinate values, Nₓ and N_{y} maximum resolution in horizontal and vertical directions, ψₘₐₓ and θₘₐₓ previously set maximum yaw and pitch angles, ψᵣ and θᵣ relative angles to the yaw and pitch angles calculated by the calculation module.

The coordinate calculator calculates primary cursor coordinate values corresponding to the first and second relative angles by using the following equations (1) and (2), and calculates final cursor coordinate values by applying the following equations (3) and (4) to the primarily calculated cursor coordinate values:

$$\begin{matrix}{P}_{x} = ( \frac{\frac{{N}_{x}}{2}}{{ψ}_{max}} ) {ψ}_{r} + \frac{{N}_{x}}{2} & ( 1 ) \\ {P}_{y} = ( \frac{\frac{{N}_{y}}{2}}{{θ}_{max}} ) {θ}_{r} + \frac{{N}_{y}}{2} & ( 2 ) \\ {P}_{nx} [ t ] = {P}_{nx} [ t - 1 ] + {P}_{x} Δ & ( 3 )\end{matrix}$$

where if |Pₓ−Pₙₓ[t−1]|≧N_{gx}, PₓΔ=floor{(Pₓ−Pₙₓ[t−1])/N_{gx}}*N_{gx}, else, PₓΔ=0

P_{ny}[t]=P_{ny}[t−1]+P_{y}Δ (4)

where if |P_{y}−P_{ny}[t−1]|≧N_{gy}, P_{y}Δ=floor{(P_{y}−P_{ny}[t−1])/N_{gy}}*N_{gy}, else, P_{y}Δ=0, where Pₓ and P_{y} represent the calculated X and Y axis primary cursor coordinate values, Nₓ and N_{y} maximum resolution in horizontal and vertical directions, ψₘₐₓ and θₘₐₓ previously set maximum yaw and pitch angles, ψᵣ and θᵣ relative angles to the yaw and pitch angles calculated by the calculation module, Pₙₓ[t] and P_{ny}[t] represents the calculated X and Y axis final cursor coordinate values, Pₙₓ[t−1] and P_{ny}[t−1] previous X and Y axis cursor coordinate values, N_{gx} an error range of the X axis coordinate, and N_{gy} an error range of the Y axis coordinate.

The input part receives pitch angle and yaw angle information computed based on output values of a geomagnetic sensor and an acceleration sensor, from the external input device having the geomagnetic sensor and the acceleration sensor, wherein the output values are calculated according to motion of the external input device.

In this case, the display device further comprises a controller controlling the operation of the display device according to a variation of roll angle information of the external input device if the roll angle information is additionally received through the input part.

According to another aspect of the present invention, there is provided an input device controlling the operation of a display device, which comprises a geomagnetic sensor module outputting yaw angle information corresponding to motion of the input device; an acceleration sensor module outputting pitch angle information corresponding to motion of the input device; a computation part computing a first relative angle corresponding to the pitch angle information and a second relative angle corresponding to the yaw angle information; a coordinate calculator calculating a cursor coordinate value for designating a position of a cursor in the display device based on a value which gradually changes according to the changes of the first and second relative angles; and a transmission part transmitting the cursor coordinate values calculated by the coordinate calculator to the display device.

The computation part computes the first and second relative angles by using the following equations (1) and (2):

θᵣ=θₜ−θᵢₙᵢₜ (1)

ψᵣ=ψₜ−ψᵢₙᵢₜ (2)

if ψᵣ≧0.0 ψᵣ<=ψᵣ−180, else ψᵣ<=ψᵣ+180
then, if ψᵣ<0.0 ψᵣ<=ψᵣ+180, else ψᵣ<=ψᵣ−180,
where θᵣ represents the first relative angle, θₜ the pitch angle, θᵢₙᵢₜ a previously set initial pitch angle, ψᵣ the second relative angle, ψₜ the yaw angle, and ψᵢₙᵢₜ a previously set initial yaw angle.

The coordinate calculator calculates primary cursor coordinate values corresponding to the first and second relative angles by using the following equations (1) and (2), and calculates final coordinate values spaced by a number of pixels around previous cursor coordinate values as the cursor coordinate values if the calculated cursor coordinate values are different from the previous cursor coordinate values by more than a number of pixels:

$$\begin{matrix}{P}_{x} = ( \frac{\frac{{N}_{x}}{2}}{{ψ}_{max}} ) {ψ}_{r} + \frac{{N}_{x}}{2} & ( 1 ) \\ {P}_{y} = ( \frac{\frac{{N}_{y}}{2}}{{θ}_{max}} ) {θ}_{r} + \frac{{N}_{y}}{2} , & ( 2 )\end{matrix}$$

where Pₓ and P_{y} represent the calculated X and Y axis primary cursor coordinate values, Nₓ and N_{y} maximum resolution in horizontal and vertical directions, ψₘₐₓ and θₘₐₓ previously set maximum yaw and pitch angles, ψᵣ and θᵣ the relative angles to the yaw and pitch angles calculated by the calculation module.

The coordinate calculator calculates primary cursor coordinate values corresponding to the first and second relative angles by using the following equations (1) and (2), and calculates final cursor coordinate values by applying the following equations (3) and (4) to the calculated primary cursor coordinate values:

$$\begin{matrix}{P}_{x} = ( \frac{\frac{{N}_{x}}{2}}{{ψ}_{max}} ) {ψ}_{r} + \frac{{N}_{x}}{2} & ( 1 ) \\ {P}_{y} = ( \frac{\frac{{N}_{y}}{2}}{{θ}_{max}} ) {θ}_{r} + \frac{{N}_{y}}{2} & ( 2 ) \\ {P}_{nx} [ t ] = {P}_{nx} [ t - 1 ] + {P}_{x} Δ & ( 3 )\end{matrix}$$

where if |Pₓ−Pₙₓ[t−1]|≧N_{gx}, PₓΔ=floor{(Pₓ−Pₙₓ[t−1])/N_{gx}}*N_{gx}, else, PₓΔ=0

P_{ny}[t]=P_{ny}[t−1]+P_{y}Δ (4)

where if |P_{y}−P_{ny}[t−1]|≧N_{gy}, P_{y}Δ=floor{(P_{y}−P_{ny}[t−1])/N_{gy}}*N_{gy}, else, P_{y}Δ=0, where Pₓ and P_{y} represent the calculated X and Y axis primary cursor coordinate values, Nₓ and N_{y} maximum resolution in horizontal and vertical directions, ψₘₐₓ and θₘₐₓ previously set maximum yaw and pitch angles, ψᵣ and θᵣ relative angles to the yaw and pitch angles calculated by the calculation module, Pₙₓ[t] and P_{ny}[t] represents the calculated X and Y axis final cursor coordinate values, Pₙₓ[t−1] and P_{ny}[t−1] previous X and Y axis cursor coordinate values, N_{gx} an error range of the X axis coordinate, and N_{gy} an error range of the Y axis coordinate.

The transmission part transmits roll angle information to the display device to allow the operation of the display device to be controlled according to the roll angle information if the roll angle information according to motion of the input device is additionally calculated from the acceleration sensor module.

According to another aspect of the present invention, there is provided a cursor display method of a display system, which comprises the steps of (a) computing a first relative angle corresponding to pitch angle information and a second relative angle corresponding to yaw angle information by using the information of the pitch and yaw angles according to motion of an external input device; (b) calculating a cursor coordinate value which gradually varies according to the changes of the first and second relative angles; and (c) displaying a cursor on a position corresponding to the calculated cursor coordinate value.

The step (a) comprises computing the first and second relative angles by using the following equations (1) and (2):

θᵣ=θₜ−θᵢₙᵢₜ (1)

ψᵣ=ψₜ−ψᵢₙᵢₜ (2)

if ψᵣ≧0.0 ψᵣ<=ψᵣ−180, else ψᵣ<=ψᵣ+180
then, if ψᵣ<0.0 ψᵣ<=ψᵣ+180, else ψᵣ<=ψᵣ−180,
where θᵣ represents the first relative angle, θₜ the pitch angle, θᵢₙᵢₜ a previously set initial pitch angle, ψᵣ the second relative angle, ψₜ the yaw angle, and ψᵢₙᵢₜ a previously set initial yaw angle.

The step (b) comprises calculating primary cursor coordinate values corresponding to the first and second relative angles by using the following equations (1) and (2), and calculating final coordinate values spaced by a number of pixels around previous cursor coordinate values as the cursor coordinate values if the calculated primary cursor coordinate values are different from the previous cursor coordinate values by more than a number of pixels:

$$\begin{matrix}{P}_{x} = ( \frac{\frac{{N}_{x}}{2}}{{ψ}_{max}} ) {ψ}_{r} + \frac{{N}_{x}}{2} & ( 1 ) \\ {P}_{y} = ( \frac{\frac{{N}_{y}}{2}}{{θ}_{max}} ) {θ}_{r} + \frac{{N}_{y}}{2} , & ( 2 )\end{matrix}$$

where Pₓ and P_{y} represent the calculated X and Y axis primary cursor coordinate values, Nₓ and N_{y} maximum resolution in horizontal and vertical directions, Φₘₐₓ and θₘₐₓ previously set maximum yaw and pitch angles, ψᵣ and θᵣ relative angles to the yaw and pitch angles calculated by the calculation module.

The step (b) comprises calculating primary cursor coordinate values corresponding to the first and second relative angles by using the following equations (1) and (2), and calculates final cursor coordinate values by applying the following equations (3) and (4) to the calculated primary cursor coordinate values:

$$\begin{matrix}{P}_{x} = ( \frac{\frac{{N}_{x}}{2}}{{ψ}_{max}} ) {ψ}_{r} + \frac{{N}_{x}}{2} & ( 1 ) \\ {P}_{y} = ( \frac{\frac{{N}_{y}}{2}}{{θ}_{max}} ) {θ}_{r} + \frac{{N}_{y}}{2} & ( 2 ) \\ {P}_{nx} [ t ] = {P}_{nx} [ t - 1 ] + {P}_{x} Δ & ( 3 )\end{matrix}$$

where if |Pₓ−Pₙₓ[t−1]|≧N_{gx}, PₓΔ=floor{(Pₓ−Pₙₓ[t−1])/N_{gx}}*N_{gx}, else, PₓΔ=0

P_{ny}[t]=P_{ny}[t−1]+P_{y}Δ (4)

where if |P_{y}−P_{ny}[t−1]|≧N_{gy}, P_{y}Δ=floor{(P_{y}−P_{ny}[t−1])/N_{gy}}*N_{gy}, else, P_{y}Δ=0,where Pₓ and P_{y} represent the calculated X and Y axis primary cursor coordinate values, Nₓ and N_{y} maximum resolution in horizontal and vertical directions, ψₘₐₓ and θₘₐₓ previously set maximum yaw and pitch angles, ψᵣ and θᵣ relative angles to the yaw and pitch angles calculated by the calculation module, Pₙₓ[t] and P_{ny}[t] represents the calculated X and Y axis final cursor coordinate values, Pₙₓ[t−1] and P_{ny}[t−1] previous X and Y axis cursor coordinate values, N_{gx} an error range of the X axis coordinate, and N_{gy} an error range of the Y axis coordinate.

The step (a) comprises receiving pitch angle and yaw angle information computed based on output values of a geomagnetic sensor and an acceleration sensor, which are calculated according to motion of the external input device having the geomagnetic sensor and the acceleration sensor.

The cursor display method may further comprise varying the operation of the display system according to a variation of a roll angle of the external input device.

### BRIEF DESCRIPTION OF THE DRAWINGS

The above and other aspects of the present invention will be more apparent by describing certain exemplary embodiments of the present invention with reference to the accompanying drawings, in which:

FIG. 1 is a diagram illustrating a display system according to an exemplary embodiment of the present invention;

FIG. 2 is a block diagram illustrating a display device according to an exemplary embodiment of the present invention;

FIG. 3 is a graph illustrating a step of finally obtaining a coordinate value of a cursor in a display device of FIG. 2;

FIG. 4 is a block diagram illustrating a display device of FIG. 2, which additionally comprises an operation control function using a roll angle;

FIG. 5 is a block diagram illustrating an input device according to an exemplary embodiment of the present invention;

FIG. 6 is a diagram illustrating an example of an arrangement direction of a geomagnetic sensor module and an acceleration sensor module in an input device of FIG. 5;

FIG. 7 is a flow chart illustrating a cursor display method according to an exemplary embodiment of the present invention;

FIG. 8 is a flow chart illustrating an example of a cursor display method additionally including a computation control function using a roll angle; and

FIG. 9 is a block diagram illustrating an example of a geomagnetic sensor module used in an input device of FIG. 5.

### DETAILED DESCRIPTION OF THE EXEMPLARY EMBODIMENTS

Exemplary embodiments of the present invention will be described in detail with reference to the annexed drawings. In the drawings, the same elements are denoted by the same reference numerals throughout the drawings. In the following description, detailed descriptions of known functions and configurations incorporated herein have been omitted for conciseness and clarity.

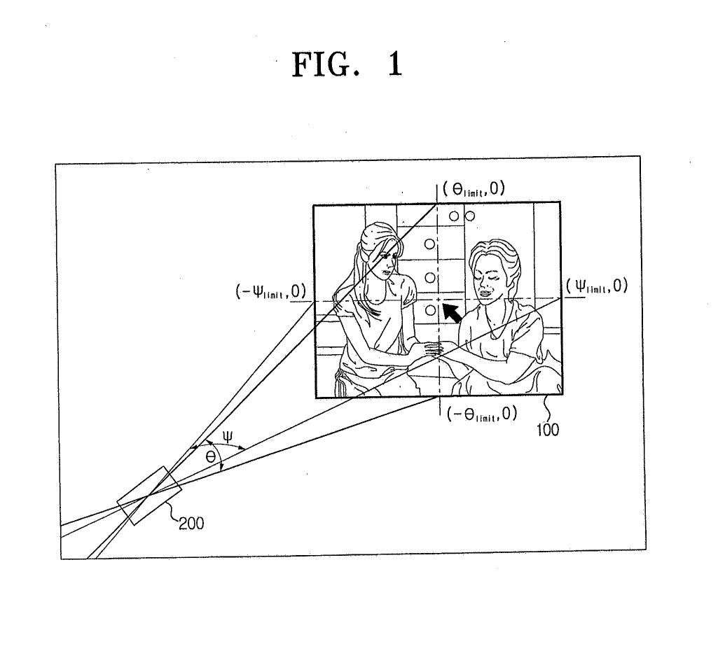

FIG. 1 is a diagram illustrating a display system according to the exemplary embodiment of the present invention. Referring to FIG. 1, the display system according to the exemplary embodiment of the present invention comprises a display device 100 and an input device 200. Examples of the display device 100 comprise a PC monitor and TV while examples of the input device 200 comprise a space mouse, a remote controller, and a cellular phone. Although the input device 200 and the display device 100 shown in FIG. 1 is a wireless type, they may be provided in a wire type.

The display device 100 displays a cursor on a screen and moves the cursor in response to motion of the input device 200. In this case, if a center coordinate of the screen is (0,0), then a pitch angle is in the range of ±θₗᵢₘᵢₜ, and a yaw angle is in the range of ±ψₗᵢₘᵢₜ. Accordingly, the cursor is controlled in the range of ±θₗᵢₘᵢₜ and ±ψₗᵢₘᵢₜ according to the pitch angle and the yaw angle of the input device 200. In other words, the cursor moves from the center coordinate of the screen in response to motion of the input device 200.

In more detail, a user may tilt the input device 200 up and down or rotate the input device 200 in left and right directions. The input device 200 has a geomagnetic sensor and an acceleration sensor therein so that information such as a pitch angle θ and a yaw angle ψ varied, according to motion of the user, can be obtained and transmitted to the display device 100.

The display device 100 moves the cursor in response to the transmitted information. In this case, the display device 100 moves the cursor to a next coordinate only if a cursor coordinate variation value corresponding to the transmitted information exceeds a predetermined value. In other words, if a coordinate motion range of the cursor is fixed in the range of three pixels, the display device 100 disregards motion less than three pixels. If it is sensed that motion exceeds three pixels, the display device 100 moves the cursor from the current coordinate to a coordinate moved at three pixels. In this way, the cursor is moved gradually, so that trembling of the cursor caused by noise can be avoided.

Meanwhile, when the display device 100 is first turned on, the cursor may be displayed on the center of the screen or may be displayed on the same position as that of the cursor directly before the display device 100 is turned off.

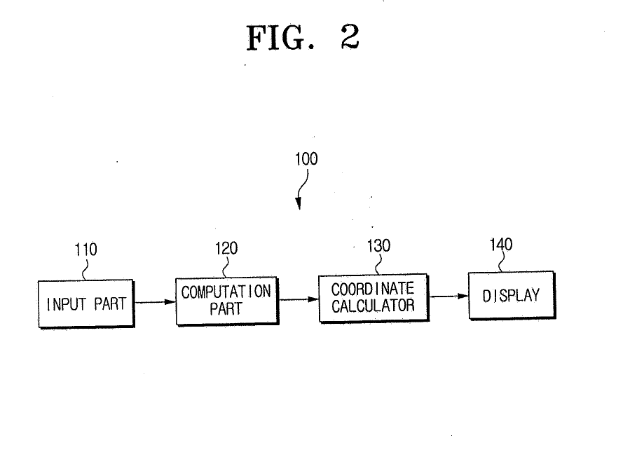

FIG. 2 is a block diagram illustrating the display device 100 according to the exemplary embodiment of the present invention. Referring to FIG. 2, the display device 100 comprises an input part 110, a computation part 120, a coordinate calculator 130, and a display 140.

The input part 110 serves to receive a signal, such as information of the pitch angle and the yaw angle, from the input device 200. Specifically, infrared (I/R) sensor can be used as the input part 110.

The computation part 120 serves to convert the information of the pitch angle and the yaw angle received through the input part 110 into a relative angle used for motion of the cursor. In other words, the pitch angle and the yaw angle may be in the range of 0˜360° or 0˜−360°. The computation part 120 serves to match the pitch angle and the yaw angle with a value in a certain range based on a screen direction of the display device 100.

For example, the computation part 120 can convert the pitch angle and the yaw angle into relative angles in the range of +90°˜−90°.

In more detail, the computation part 120 can compute the relative angles using the following equations.

[Equation 1]

θᵣ=θₜ−θᵢₙᵢₜ (1)

ψᵣ=ψₜ−ψᵢₙᵢₜ (2)

if ψᵣ≧0.0 ψᵣ<=ψᵣ−180, else ψᵣ<=ψᵣ+180
then, if ψᵣ<0.0 ψᵣ<=ψᵣ+180, else ψᵣ<=ψᵣ−180,

In the equation 1, (1) is a computation equation of the relative angle to the pitch angle, and (2) is a computation equation of the relative angle to the yaw angle. In the equation 1, θᵣ represents a first relative angle, θₜ the pitch angle, θᵢₙᵢₜ a previously set initial pitch angle, ψᵣ a second relative angle, ψₜ the yaw angle, and ψᵢₙᵢₜ a previously set initial yaw angle.

Meanwhile, the computation resultant value obtained by (2) of the equation 1 undergoes two control steps according to whether the resultant value is more than 0. In other words, a first control step is performed, wherein 180 is subtracted if the computation resultant value is more than 0 and 180 is added if the computation resultant value is less than 0. Then, a second control step is performed, wherein 180 is added if the controlled resultant value is less than 0, and 180 is subtracted if the controlled resultant value is more than 0. As a result, the relative angle to the yaw angle can exactly be obtained.

For example, supposing that the display device 100 is spaced apart from 10° in a left direction around the north 0°, i.e., supposing that the display device 100 is arranged at an azimuth angle of 350°, ψᵢₙᵢₜ is equal to 350. In this state, if the input device 200 is rotated at 20° in a right direction around the direction where the display device 100 is arranged, 10−350=−340 is obtained according to (2) of the equation 1. In this case, if the first control step is performed, −340+180=−160 is obtained because −340 is less than 0. Then, if the second control step is performed, −160+180=20 is obtained because −160 is less than 0. Finally, it is possible recognize that the display device 100 has been rotated at 20° in a right direction.

The coordinate calculator 130 serves to calculate a cursor coordinate value corresponding to the relative angle calculated by the computation part 120. In other words, if the input device 200 is rotated in a right direction, the coordinate calculator 130 increases an X axis coordinate value of the cursor coordinate value in response to the rotated range. By contrast, if the input device 200 is rotated in a left direction, the coordinate calculator 130 decreases the X axis coordinate value of the cursor coordinate value. Alternatively, if the input device 200 is tilted toward an up direction from a previous position, the coordinate calculator 130 increases a Y axis coordinate value of the cursor coordinate value. By contrast, if the input device 200 is tilted toward a down direction, the coordinate calculator 130 decreases the Y axis coordinate value of the cursor coordinate value.

In this case, the coordinate calculator 130 calculates primary X and Y coordinate values corresponding to the relative angle, and then calculates the final calculated cursor coordinate values only if the calculated coordinate values are different from previous coordinate values by more than a predetermined number of pixels. By contrast, if the calculated coordinate values are different from previous coordinate values by less than a predetermined number of pixels, the coordinate calculator 130 maintains the previous cursor coordinate values without change. In other words, if the calculated coordinate values are different from previous coordinate values by less than a predetermined number of pixels, the coordinate calculator 130 regards it as the difference caused by noise and disregards it. Specifically, the coordinate calculator 130 can calculate the cursor coordinate values using the following equation.

$$\begin{matrix}[ Equation 2 ] & \\ {P}_{x} = ( \frac{\frac{{N}_{x}}{2}}{{ψ}_{max}} ) {ψ}_{r} + \frac{{N}_{x}}{2} & ( 1 ) \\ {P}_{y} = ( \frac{\frac{{N}_{y}}{2}}{{θ}_{max}} ) {θ}_{r} + \frac{{N}_{y}}{2} & ( 2 )\end{matrix}$$

In the equation 2, (1) is to calculate the X axis coordinate value and (2) is to calculate the Y axis coordinate value. In the equation 2, Pₓ and P_{y} represent the calculated X and Y axis primary cursor coordinate values, Nₓ and N_{y} maximum resolution in horizontal and vertical directions, ψₘₐₓ and θₘₐₓ previously set maximum yaw and pitch angles, ψᵣ and θᵣ relative angles to the yaw and pitch angles calculated by the calculation module 120. For example, supposing that the maximum resolution in horizontal and vertical directions is 1280*1024, the maximum yaw angle is 90°, the maximum pitch angle is 90°, the minimum yaw angle is −90°, and the minimum pitch angle is −90°, if the input device 200 is tilted at 20° in a right direction and at 10° in a down direction, Pₓ is substantially 782 and P_{y} is substantially 455.

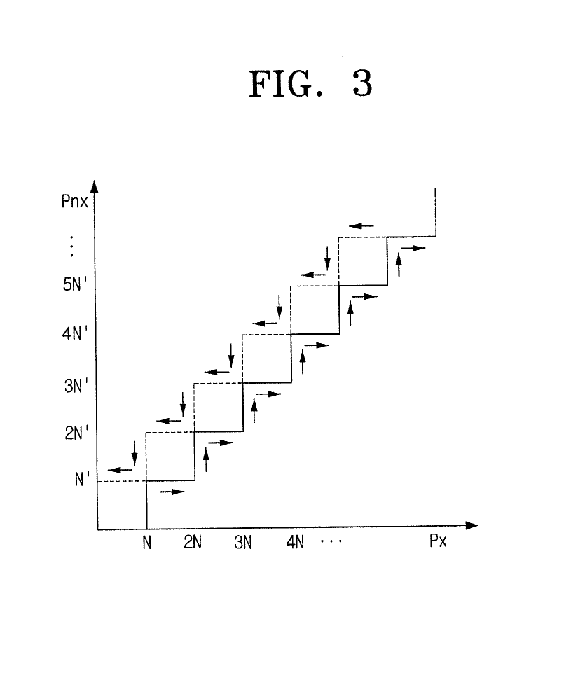

Meanwhile, the coordinate calculator 130 may calculate the final cursor coordinate values by applying the cursor coordinate values calculated by the equation 2 to a graph of FIG. 3.

FIG. 3 illustrates two graphs differently applied according to a cursor motion direction. In FIG. 3, a horizontal axis represents the primarily calculated X axis coordinate value, and a vertical axis represents the calculated X axis final cursor coordinate value.

Referring to FIG. 3, the cursor coordinate values are calculated along a solid line graph in an X axis direction, and they are calculated along a dotted line graph in an −X axis direction. First, the case where the cursor moves along the +X axis direction will be described. If the calculated primary cursor coordinate values are in the range of N˜2N, then N′ is calculated. In this state, the previous cursor coordinate values are maintained until the calculated cursor coordinate values reach 2N. When the calculated cursor coordinate values exceed 2N, the X axis cursor coordinate value increases by one level to calculate 2N′. As another example, if the current cursor coordinate values are in the range of 3N˜4N, 3N′ is maintained until the calculated cursor coordinate values reach 4N. When the calculated cursor coordinate values exceed 4N, the X axis cursor coordinate value increases to 4N′.

Meanwhile, in a state where the cursor coordinate values increase to 4N′, the case where the cursor moves in a −X axis direction will be described. Even if the current cursor coordinate reaches 4N in a left direction in a state where it is maintained between 4N and 5N, the current cursor coordinate values of 4N′ are maintained. In this state, if the cursor moves to the left to 3N, 3N′ is calculated as a final cursor coordinate value. In other words, if the cursor moves to the left, it moves along the dotted line of the graph.

Although FIG. 3 illustrates graphs around the X axis coordinate value, the same graph as that of the X axis coordinate value may be applied to the Y axis coordinate value. The description and drawing of the Y axis coordinate value will be omitted. Meanwhile, an increase and decrease range of the cursor coordinate values, i.e., values N, N′ can optionally be set at 3 to 5 pixels, so that the cursor display position moves gradually from the center coordinate (Nx/2, Ny/2) according to the yaw angle.

The step of calculating the cursor coordinate values using the graph of FIG. 3 will be expressed by the following equation.

[Equation 3]

Pₙₓ[t]=Pₙₓ[t−1]+PₓΔ (1)

where if |Pₓ−Pₙₓ[t−1]|≧N_{gx}, PₓΔ=floor{(Pₓ−Pₙₓ[t−1])/N_{gx}}*N_{gx}, else, PₓΔ=0

P_{ny}[t]=P_{ny}[t−1]+P_{y}Δ (2)

where if |P_{y}−P_{ny}[t−1]|≧N_{gy}, P_{y}Δ=floor{(P_{y}−P_{ny}[t−1])/N_{gy}}*N_{gy}, else, P_{y}Δ=0

In the equation 3, (1) is for the X axis coordinate value and (2) is for the Y axis coordinate value. In the equation 3, Pₙₓ[t] and P_{ny}[t] represents the calculated X and Y axis final cursor coordinate values, Pₙₓ[t−1] and P_{ny}[t−1] previous X and Y axis cursor coordinate values, N_{gx} an increase and decrease range of the X-axis coordinate, and N_{gy} an increase and decrease range of the Y-axis coordinate.

In (1) of the equation 3, the finally calculated X axis coordinate value is obtained by adding PxΔ to the previous X axis coordinate value, wherein PxΔ has a specific value only if the difference between the previous X axis coordinate value and the primarily calculated X axis coordinate value is in the increase and decrease range of the X axis coordinate, i.e., more than Ngx, and is equal to 0 in other cases. In other words, if the difference is less than Ngx, the cursor does not move. If the difference is more than Ngx, it is noted that PxΔ can be obtained by multiplying Ngx and quotient obtained by dividing the difference between the previous X axis coordinate value and the calculated X axis primary coordinate value by Ngx. Since (2) of the equation 3 can be expressed in the same manner as (1), its description will be omitted.

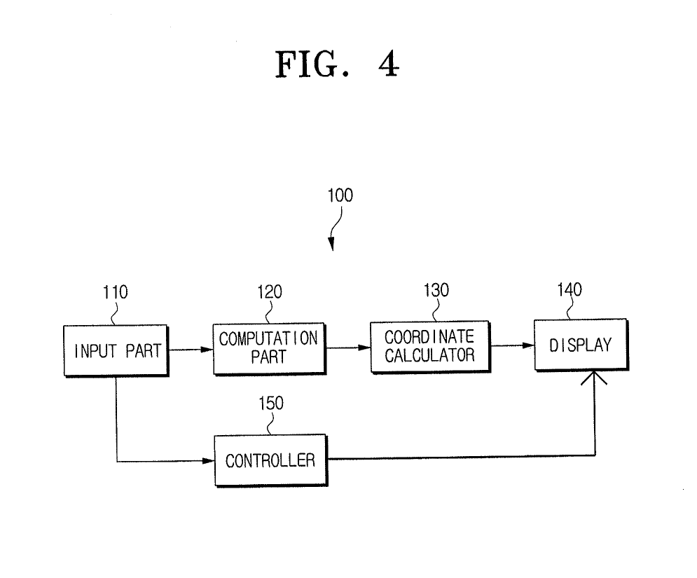

FIG. 4 is a block diagram illustrating the display device of FIG. 2, which additionally comprises a computation control function using a roll angle. Specifically, the input device 200 may measure a roll angle in addition to the pitch angle and the yaw angle and provide the measured roll angle to the display device 100. The display device 100 of FIG. 4 relates to an example which uses a roll angle. The display device of FIG. 4 further comprises a controller 150 in addition to the input part 110, the computation part 120, the coordinate calculator 130 and the display 140.

The input part 110 additionally receives information of the roll angle from the input device 200. The controller 150 can control the operation of the display device 100 according to variation of the roll angle. For example, a broadcasting channel number can be controlled according to variation of the roll angle. In other words, if the input device 200 is tilted in a right direction, the broadcasting channel number is controlled in an increasing direction. If the input device 200 is tilted in a left direction, the broadcasting channel number is controlled in a decreasing direction. The broadcasting channel can be selected by a tuner (not shown) under the control of the controller 150.

As another example, the controller 150 can control sound volume of the display device 100 according to a variation of the roll angle. In other words, if the input device 200 is tilted in a right direction, the sound volume can be increased. If the input device 200 is tilted in a left direction, the sound volume can be decreased.

In addition, the size of an image to be displayed, a contrast ratio, and white balance can be controlled according to the roll angle.

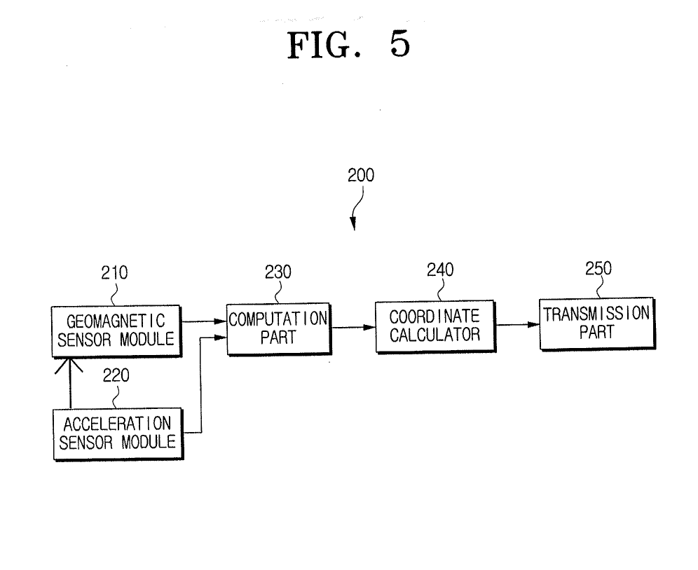

Meanwhile, the relative angles to the pitch angle and the yaw angle varied by motion of the input device 200 and the cursor coordinate values may be calculated by the input device 200. In this case, the input device 200 may calculate the values for the gradual changes of the cursor coordinates, and then provide the results to the display device 100, instead of constructing the display device 100 as shown in FIG. 2 or 4. The display device 100 according to the above alternative example is shown in FIG. 5.

FIG. 5 is a block diagram illustrating the input device 200 according to the exemplary embodiment of the present invention. Referring to FIG. 5, the input device 200 comprises a geomagnetic sensor module 210, an acceleration sensor module 220, a computation part 230, a coordinate calculator 240, and a transmission part 250.

The geomagnetic sensor module 210 measures an electrical signal corresponding geomagnetism to calculate the yaw angle. The detailed constitution of the geomagnetic sensor module 210 will be described later.

The acceleration sensor module 220 serves to calculate the pitch angle and/or the roll angle by measuring a tilt of the input device 200. Specifically, the acceleration sensor module 220 can calculate the pitch angle and the roll angle by using a two-axis acceleration sensor or a three-axis acceleration sensor.

If the two-axis acceleration sensor is used, the acceleration sensor module 220 comprises X and Y axis acceleration sensors (not shown) orthogonal to each other. In this case, the acceleration sensor module 220 normalizes output values of the X and Y axis acceleration sensors using the following equation and then calculates the pitch angle and the roll angle using the normalized values.

$$\begin{matrix}[ Equation 4 ] & \\ {Xt}_{norm} = \frac{( Xt - {Xt}_{offset} )}{{Xt}_{Scale}} \\ {Yt}_{norm} = \frac{( Yt - {Yt}_{offset} )}{{Yt}_{Scale}} \\ {Xt}_{offset} = \frac{{Xt}_{max} + {Xt}_{min}}{2} , \\ {Xt}_{Scale} = \frac{{Xt}_{max} - {Xt}_{min}}{2} \\ {Yt}_{offset} = \frac{{Yt}_{max} + {Yt}_{min}}{2} , \\ {Yt}_{Scale} = \frac{{Yt}_{max} - {Yt}_{min}}{2} & \end{matrix}$$

In the equation 4, Xt and Yt respectively represents output values of the X and Y axis acceleration sensors, Xₜₙₒᵣₘ and Ytₙₒᵣₘ normalized values of the X and Y axis acceleration sensors, Xtₘₐₓ and Xtₘᵢₙ maximum and minimum values of Xt, Ytₘₐₓ and Ytₘᵢₙ maximum and minimum values of Yt, Xt_{offset} and Yt_{offset} offset values of the X and Y axis acceleration sensors, and Xt_{Scale} and Y_{tscale} scale values of the X and Y axis acceleration sensors. Xt_{offset}, Yt_{offset}, Xt_{Scale}, Yt_{Scale} may be calculated by rotation of the acceleration sensor module 220 or the input device 200 and stored in a memory (not shown) of the acceleration sensor module 220.

The acceleration sensor module 220 can calculate the pitch angle and the roll angle by substituting the normalized values of the acceleration sensors for the following equation.

$$\begin{matrix}[ Equation 5 ] & \\ θ = {sin}^{- 1} ( {Xt}_{norm} ) \\ φ = {sin}^{- 1} ( \frac{{Yt}_{norm}}{cos θ} ) & \end{matrix}$$

In the equation 5, θ represents the pitch angle, and φ represents the roll angle.

The acceleration sensor module 220 provides the calculated pitch and roll angles to the computation part 230 and also provides them to the geomagnetic sensor module 210 so that the geomagnetic sensor module 210 can use them to compensate an azimuth angle.

The computation part 230 computes the relative angles by using the calculated yaw and pitch angles, and the coordinate calculator 240 calculates the values for the gradual changes of the cursor coordinates, by using the calculated relative angles. The computation part 230 and the coordinate calculator 240 are operated in the same manner as those of FIGS. 2 and 3. In other words, the computation part 230 can calculate the relative angles by using the equation 1 while the coordinate calculator 240 can calculate the cursor coordinate values by using the equations 2 and 3.

The transmission part 250 transmits the calculated cursor coordinate values to the display device 100 to display the cursor on the position corresponding to the cursor coordinate values of the display device 100.

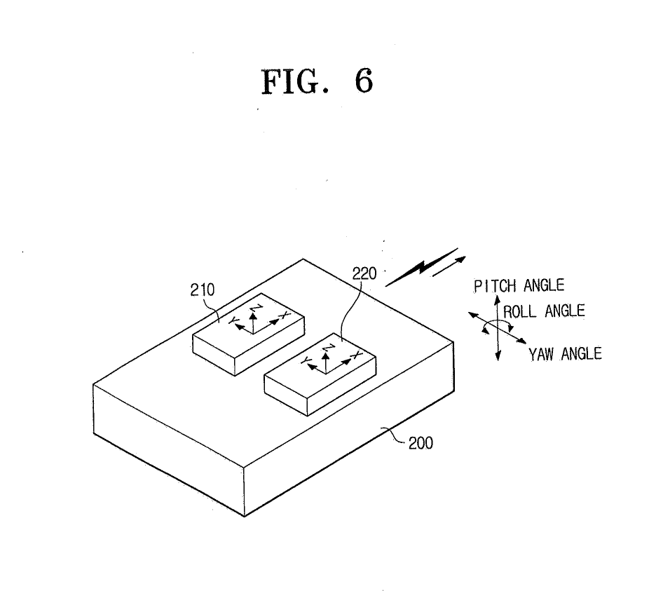

FIG. 6 is a diagram illustrating an example of the input device 200 in the display device of FIG. 1. Referring to FIG. 6, the geomagnetic sensor module 210 and the acceleration sensor module 220 in the input device 200 respectively comprise three-axis flux gates, wherein the X axis flux gate is arranged in the front end of the input device 200, i.e., toward the display device 100. Meanwhile, the Y axis flux gate is arranged vertically to the X axis flux gate, and the Z axis flux gate is arranged vertically to a plane where the X and Y axis flux gates are arranged. In this state, the pitch angle is varied if the input device is rotated around the Y axis flux gate, the yaw angle is varied if the input device is rotated around the Z axis flux gate, and the roll angle is varied if the input device is rotated around the X axis flux gate.

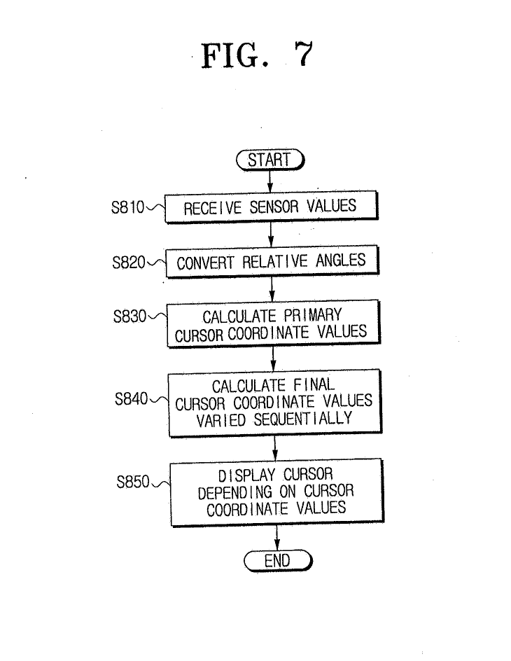

FIG. 7 is a flow chart illustrating a cursor display method according to an exemplary embodiment of the present invention. Referring to FIG. 7, if sensor values indicating the pitch angle and the yaw angle are received (S810), the relative angles are calculated by using the received sensor values (S820). The relative angles can be calculated by using the equation 1.

Then, the cursor coordinate values are primarily calculated by using the relative angles (S830). The cursor coordinate values can be calculated by using the equation 2.

Afterwards, the calculated primary cursor coordinate values are compared with previous cursor coordinate values to calculate final cursor coordinate values (S840). In this case, the final cursor coordinate values can be calculated by using the equation 3.

In this way, if the final cursor coordinate values are calculated, the cursor is displayed according to the calculated values (S850).

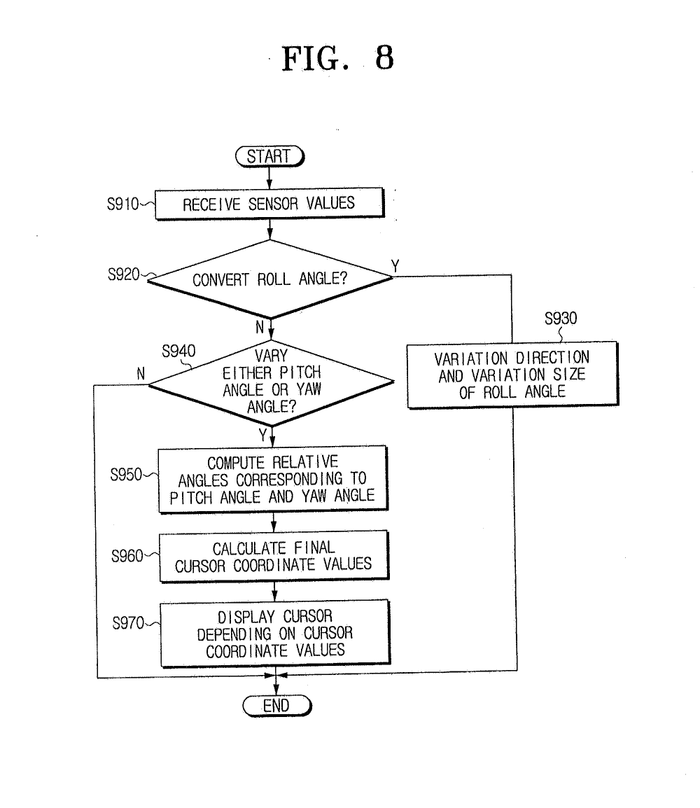

FIG. 8 is a flow chart illustrating an example of the cursor display method additionally including a computation control function using the roll angle. Referring to FIG. 8, if the sensor values are received (S910), it is checked whether the roll angle of the input device 200 has been varied (S920). As a result, if the roll angle has been varied, a channel number is changed based on the direction and size of the variation of the roll angle (S930). Although FIG. 8 illustrates the channel change only, the sound volume and other functions may be controlled by the roll angle.

Meanwhile, if either the pitch angle or the yaw angle has been varied (S940), the relative angle corresponding to the pitch angle or the yaw angle is calculated (S950). The relative angle can be calculated by using the equation 1.

The cursor coordinate values are calculated by using the calculated relative angle (S960), and the cursor is displayed according to the calculated cursor coordinate values (S970). The calculation manner of the cursor coordinate values has been described as above.

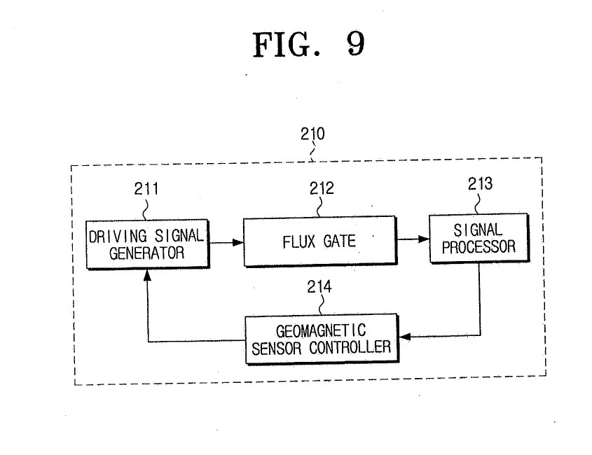

FIG. 9 is a block diagram illustrating an example of the geomagnetic sensor module 210 used in the input device 200 of FIGS. 1 and 5. Referring to FIG. 9, the geomagnetic sensor module 210 comprises a driving signal generator 211, a flux gate 212, a signal processor 213, and a geomagnetic sensor controller 214.

The driving signal generator 211 serves to generate a driving signal for exciting the flux gate 212. The driving signal generator 211 generates a driving signal such as pulse and inverse pulse and provides the driving signal to the flux gate 212.

The flux gate 212 is excited by the driving signal to output a voltage value corresponding to geomagnetism. The flux gate 212 can be realized by three axes or two axes. If the flux gate 212 is realized by two axes, X and Y axis flux gates orthogonal to each other are provided. If the flux gate 212 is realized by three axes, X, Y and Z axis flux gates orthogonal to one another are provided.

The signal processor 213 converts output values of the respective axes output from the flux gate 212 into digital voltage values and outputs them. Specifically, the signal processor 213 may comprise a chopping circuit, an amplifying circuit, a filter and an analog-to-digital (A/D) converter. The signal processor 213 converts the electrical signal output from the flux gate 212 into the digital voltage value after chopping, amplifying and filtering it.

The geomagnetic sensor controller 214 performs normalization for mapping the output values of the respective axes provided from the signal processor 213 with values in a previously set range. The normalization range can optionally be set. Specifically, the normalization range can be set in the range of −1 to +1.

If the flux gate 212 is realized by three axes, the geomagnetic sensor controller 214 can perform normalization by using the following equation.

$$\begin{matrix}[ Equation 6 ] & \\ {X}_{norm} = \frac{( {X}_{raw} - {X}_{offset} )}{{X}_{Scale}} \\ {Y}_{norm} = \frac{( {Y}_{raw} - {Y}_{offset} )}{{Y}_{Scale}} \\ {Z}_{norm} = \frac{( {Z}_{raw} - {Z}_{offset} )}{{Z}_{Scale}} & \end{matrix}$$

In the equation 6, Xₙₒᵣₘ, Yₙₒᵣₘ, Zₙₒᵣₘ respectively represent normalization values of the X, Y, Z axis flux gates, X_{raw}, Y_{raw}, Z_{raw} actual output values of the X, Y, Z axis flux gates, X_{offset}, Y_{offset}, Z_{offset} offset values of the X, Y, Z axis flux gates, and X_{scale}, Y_{scale}, Z_{scale} scale values of the X, Y, Z axis flux gates.

The offset values and the scale values mean normalizing factors used for normalization. The offset and scale values previously set and stored in the memory may be used as the offset and scale values. Meanwhile, if there are no previously set offset and scale values, i.e., if the azimuth compensation work is performed for the first time, the geomagnetic sensor is rotated one time to calculate the offset and scale values. Specifically, the offset and scale values can be calculated by using the following formula.

$$\begin{matrix}[ Equation 7 ] & \\ {X}_{offset} = \frac{{X}_{max} + {X}_{min}}{2} , \\ {X}_{scale} = \frac{{X}_{max} - {X}_{min}}{2} \\ {Y}_{offset} = \frac{{Y}_{max} + {Y}_{min}}{2} , \\ {Y}_{scale} = \frac{{Y}_{max} - {Y}_{min}}{2} \\ {Z}_{offset} = \frac{{Z}_{max} + {Z}_{min}}{2} , \\ {Z}_{scale} = \frac{{Z}_{max} - {Z}_{min}}{2} & \end{matrix}$$

In the equation 7, Xₘₐₓ, Yₘₐₓ, Zₘₐₓ respectively represent maximum values of X_{raw}, Y_{raw}, Z_{raw}, and Xₘᵢₙ, Yₘᵢₙ, Zₘᵢₙ respectively represent minimum values of X_{raw}, Y_{raw}, Z_{raw}. A manufacturer of the geomagnetic sensor according to the present invention senses Xₘₐₓ, Yₘₐₓ, Zₘₐₓ, Xₘᵢₙ, Yₘᵢₙ, Zₘᵢₙ while rotating the geomagnetic sensor several times. The manufacturer of the geomagnetic sensor can perform an initial computation of the offset values and the scale values by substituting the sensed values for the equation 5, and store the resultant offset and scale values in the memory. Thus, the offset and scale values stored in the memory are used as the normalizing factors for normalization during the yaw angle compensation work.

The geomagnetic sensor controller 214 may calculate the yaw angle from the normalized output values of the respective axes but may compensate the yaw angle by using the pitch angle and the roll angle provided from the geomagnetic sensor module 220. Specifically, the geomagnetic sensor controller 214 can calculate the yaw angle by using the following equation.

$$\begin{matrix}[ Equation 8 ] & \\ ψ = {tan}^{- 1} ( \frac{{Y}_{norm} * cos φ - {Z}_{norm} * sin φ}{{X}_{norm} * cos θ - {Y}_{norm} * sin θ * sin φ - {Z}_{norm} * sin θ * cos φ} ) & \end{matrix}$$

In the equation 8, Xₙₒᵣₘ, Yₙₒᵣₘ, Zₙₒᵣₘ respectively represent the normalized output values of the X, Y, and Z axis flux gates, θ represents the pitch angle, and φ represents the roll angle. The equation 8 is obtained by setting a value of the Z axis vertical to a horizontal plane as a negative number. A sign of the equation 8 may be varied according to arrangement of the three axis flux gates in the geomagnetic sensor module 210.

Meanwhile, if the flux gate 212 is realized by two axes, since the output value of the Z axis cannot be sensed directly, a virtual output value of the Z axis can be calculated as expressed by the following equation to calculate the yaw angle. In other words, the yaw angle can be calculated by substituting the computation resultant value of the following equation for the equation 8.

$$\begin{matrix}[ Equation 9 ] & \\ {Zf}_{norm} = \frac{( {Xf}_{norm} * sin θ - {Yf}_{norm} * cos θ * sin φ + sin λ )}{cos θ * cos φ} & \end{matrix}$$

In the equation 9, Zfₙₒᵣₘ represents the normalized voltage value of the virtual Z axis, λ magnetic dip angle, θ the pitch angle, and φ the roll angle. Meanwhile, in addition to the aforementioned calculation manner, the known process may be used to calculate the pitch angle, the roll angle and the yaw angle.

In the cursor display method according to the present invention, motion of the cursor to the X axis direction and motion of the cursor to the Y axis direction are removed in a state where the motion of the input device 200 is stopped. Also, since no filtering is separately required, motion of the cursor to the X and Y axis directions immediately responds to motion of the input device 200, whereby time delay does not occur.

As described above, according to the exemplary embodiment of the present invention, the display device for displaying the cursor according to motion of the input device and the display system, which comprises the display device, are disclosed. In the display device or the input device according to the present invention, in case of no motion of the input device, the cursor is moved gradually so that motion of the cursor, which is caused by noise, can be avoided. Accordingly, trembling of the cursor can completely be removed so as not to cause the user inconvenience. Also, since no filter such as a Bessel filter is used, time delay due to filtering does not occur. Accordingly, since motion of the cursor immediately responds to motion of the input device, the user's convenience can be improved.

The foregoing exemplary embodiment and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A display system including a display device, comprising:
a geomagnetic sensor which senses motion of an input device;
an acceleration sensor which senses motion of the input device;
an input device which includes a transmission part that transmits information of the input device sensed by the geomagnetic sensor or the acceleration sensor;
a receiving part which receives motion information of the input device from the transmission part;
a display which displays a cursor at a position corresponding to the motion information; and
a controller which controls the display to determine a position where the cursor needs to be displayed with reference to a predetermined position on a screen of the display in accordance with the motion information and to display the cursor at the determined position.

2. A display system including an input device and a display device, wherein the input device comprises
a geomagnetic sensor which senses motion of the input device;
an acceleration sensor which senses motion of the input device;
an input part which includes an input device including a transmission part that transmits information corresponding to the sensed motion of the input device and, wherein the display device comprises an input part which receives information corresponding to motion of the input device from the transmission part;
a display which displays a cursor at a position corresponding to motion of the input device; and
a control unit which calculates a relative angle based on motion information of the input device, which is included in the received information, calculates coordinate values based on a variation in the relative angle, and controls the display to move the cursor based on the coordinate values,
wherein an angle range by which the cursor is moved is less than an angle range of the motion of the input device, which is included in the received information.

3. The display system of claim 2, wherein the control unit moves the cursor with respect to a particular location on a screen of the display.

4. The display system of claim 3, wherein the particular location is the center of the screen of the display.

5. A method for controlling a display device, comprising:
sensing at least one of motion of an input device corresponding to a yaw angle, motion of the input device corresponding to a pitch angle, and motion of the input device corresponding to a roll angle using a geomagnetic sensor and an acceleration sensor; and
if the sensed motion of the input device is motion corresponding to a pitch angle, moving a cursor displayed on a screen of a display in a vertical direction, if the sensed motion of the input device is motion corresponding to a yaw angle, moving a cursor displayed on a screen of the display in a horizontal direction, and if the sensed motion of the input device is motion corresponding to a roll angle, controlling a predetermined operation of the display,
wherein the operation of the display is not an operation of moving a cursor.
